(19) United States
(12) Patent Application Publication
(10) Pub. No.: US 2017/0061660 A1
(43) Pub. Date: Mar. 2, 2017

(54) Data Visualization Mapping Platform

(71) Applicant: RippleNami Inc., Cardiff, CA (US)

(72) Inventors: Philip Randall Gahn, Cardiff, CA (US); Richard James Hinrichs, Cardiff, CA (US); Julianne Connolly, Cardiff, CA (US)

(21) Appl. No.: 15/256,218

(22) Filed: Sep. 2, 2016

Related U.S. Application Data
(60) Provisional application No. 62/213,333, filed on Sep. 2, 2015.

(51) Int. Cl. G06T 11/20; G06T 11/60

(52) U.S. Cl. CPC G06T 11/206; G06T 11/60; G06F 3/04842

(57) ABSTRACT

A computer-implemented method, non-transitory medium having machine instructions and/or system having memory and a processor may perform operations including displaying in a first region on a display screen, at least a portion of a map depicting a geographical area; receiving user input specifying one or more data feeds, each data feed corresponding to a type of aspects, each aspect having an associated geographical location; making each data feed available in a second display region on the screen; receiving user input specifying data feeds available in the second display region to make active; and for each data feed in the second display region made active, displaying a layer of visual indications (e.g., icons) on the displayed map, wherein each visual indication in the layer corresponds to a different aspect provided by the corresponding data feed, and each visual indication is displayed on the map at its associated geographical location.

### CROSS-REFERENCE TO RELATED APPLICATIONS

This application claims priority to U.S. Application Ser. No. 62/213,333, filed on Sep. 2, 2015, the entire contents of which are incorporated herein by reference.

### TECHNICAL FIELD

This disclosure relates to data visualization.

### BACKGROUND

Enterprises such as corporations, disaster relief and management entities, foreign governments, emergency response organizations, non-government organizations (NGOs) and the like often must manage, deploy and/or share multiple resources with other entities such as other enterprises or individuals or both, oftentimes on an emergency or otherwise expedited basis. At the same time, enterprises often must keep track of multiple different events of differing types in order to deploy their resources wisely and efficiently. Depending on the nature and quantity of resources and events involved, keeping track of the resources and events can be challenging.

### SUMMARY

This disclosure relates to data visualization, e.g., mapping layers of data to a geographical map to show locations and potentially other information and aspects, such as events, resources, characteristics, or the like.

In an exemplary implementation, a computer-implemented method, a non-transitory medium having machine instructions and/or a system having memory and a processor may perform operations including displaying in a first region (e.g., a map region) on a display screen, at least a portion of a map depicting a user-specified geographical area; receiving user input specifying one or more data feeds, each data feed corresponding to an aspect, such as a type of characteristics, each aspect or characteristic having an associated geographical location (which may be a point or an area, and may be precise or an estimate, and if an area may be of any shape, any border of which may be regular or irregular); making each specified data feed available in a second display region (e.g., a tray region) on the display screen; receiving user input specifying one or more data feeds available in the second display region to make active; and for each data feed in the second display region made active, displaying a layer of visual indication (e.g., icons, colors, effects) on top of or integrated into the displayed map, wherein each visual indication in the layer corresponds to a different characteristic provided by the corresponding data feed, and each visual indication is displayed on the map at or in conjunction with its associated geographical location. While a visual indicator layer may be logically or conceptually separate from other layers or the base map, it may be displayed separately or such that it appears an integral part of another layer and/or the base map. For example, a layer of visual indicators might be displayed as icons over locations, or by making some locations a different color, or altering the color gradient, intensity, or opacity of some location(s), or applying other effects to some location(s). For example, a layer associated with fire events might be displayed as icons at the locations of fires, while a layer associated with population density might be displayed by modifying the color or color gradient or intensity of a location, while rainfall in the preceding 30 days might be displayed as a wavy or other effect of varying intensity within areas of the base map.

The displayed map may be zoom-able and translatable to allow different or additional portions of the map to be displayed.

The data feeds may correspond to naturally occurring events or human initiated events or aspects or characteristics (for example, population density, precipitation, hazardous material locations, types of housing (single-family, multi-family, high-density, assisted-living, etc.)).

The second display region may be implemented as a virtual tray that is superimposed over the first displayed region.

Receiving user input to make a data feed in the tray active may involve selecting (e.g., clicking on, pointing at, gesturing towards) an identifier corresponding to the desired data feed.

The method, system, and/or machine-readable medium may further include an operation for displaying a plurality of layers of visual indications on top of the displayed map, each layer of visual indications corresponding to one or more different characteristics.

The displayed visual indications may have an appearance that suggests the characteristic type to which they correspond (for example, fires might be indicated by flame-shaped icons, precipitation or flooding by applying a wavy effect to an area, etc.).

The method, system and/or machine-readable medium may further include a third display region (e.g., a display window for displaying available data feeds that can be moved to the second display region) having a plurality of data feeds for selection by the user to make available in the second display region.

The method, system and/or machine-readable medium may further include capturing a snapshot of the map with one or more layers of visual indications displayed on top, the snapshot corresponding to a particular moment in time.

The map may be displayed as a base map, a terrain map, a satellite map, or any combination thereof.

### BRIEF DESCRIPTION OF THE DRAWINGS

FIGS. 1-3 illustrate various views of a data visualization mapping platform display screen.

FIG. 4 is a flowchart of a process of operation by a data visualization mapping platform.

FIG. 5. is a block diagram of devices that may be used to implement the systems and methods described in this document.

Like reference numbers and designations in the various drawings indicate like elements.

### DETAILED DESCRIPTION

This disclosure relates to data visualization, e.g., by super-imposing layers of data on to a geographical map to show locations and potentially other information about aspects such as events, resources, other characteristics or the like. As used herein, a “location” may refer to particular geographic coordinates (e.g., a latitude and longitude pair corresponding to a point on a map), a specific delineated area covering, e.g., a specified radius around a specific point, one or more lots, blocks, acres, counties, states, countries, continents, etc., an approximate area or point, a telecommunications cell region, the location of a radio beacon, even if moving, or the like. The layers of data come from one or more of multiple different data feeds. Each data feed corresponds to a category of information, e.g., events, resources, or essentially any other characteristic having or associated with a geographical location, that may be of interest to an enterprise or user, and which can be graphically indicated on a map. For example, a data feed may correspond to currently active wildfires in the continental United States. In that case, the data feed would provide information about each wildfire event, e.g., its geographical location, extent, intensity, date initiated, cause, status, and/or any other potentially relevant information.

Data feeds need not relate only to events, however, but alternatively, or in addition, may relate to things such as resources. For example, in the above example in which one data feed provides information about wildfire events, another data feed may provide information about firefighting resources, including their location, availability, size, capabilities, and the like. In such an example, information from both data feeds—i.e., both wildfire events and firefighting resources—could be displayed at their respective locations on a map, thereby giving a user a graphical and intuitive sense of which events need attention, and with what level of priority, and which resources are available and appropriate to deploy to attend to those events. More generally, the data feeds can correspond to essentially any other characteristic that potentially may affect the decision-making process in terms of what actions to take in a certain situation (e.g., which resources to deploy, and how and where). Examples of such characteristics include not only events and resources themselves, but also things such as average population density, the presence of hazardous materials, the presence or density of single family homes, multi-family homes, commercial structures, precipitation (such as average or over a period of time, such as preceding 30 days), quarantined areas, and the like.

The data feeds may come from any of multiple different sources. For example, services such as Global Incident Map (www.globalincidentmap.com) are available that provide various different data feeds that may be used for that purpose. Alternatively, or in addition, an enterprise may create its own data feeds as desired to better serve its goals and mission.

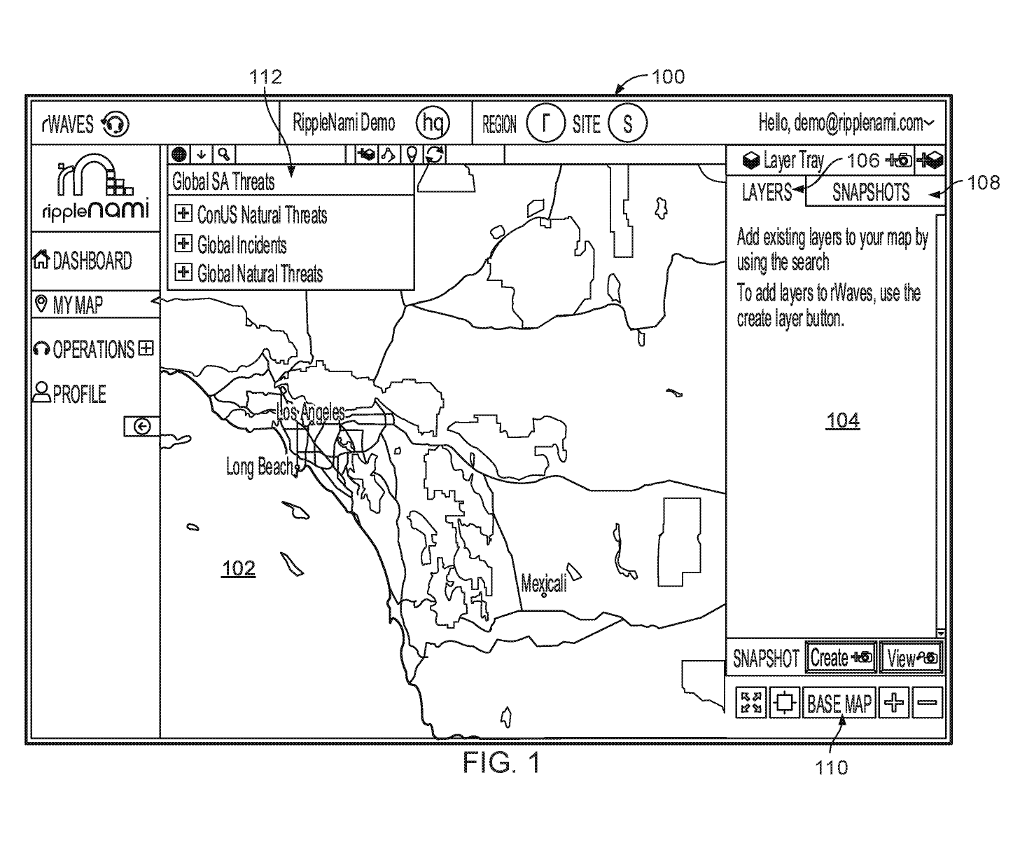

FIG. 1 shows an example of a screenshot of the data visualization mapping platform described here. As shown, the screenshot 100 includes a geographical map portion 102, a virtual tray 104 (having a Layers tab 106 and a Snapshots tab 108), a Map View drop-down selector 110, and an expandable data feeds portion 112. The map portion 102 can be manipulated by the user using standard graphical user interface (GUI) operations (e.g., zoom, rotate, translate) to show essentially any portion of the map (e.g., the Earth's surface) as desired. As shown, the user has manipulated the GUI such that the map portion 102 shows a geographical region roughly corresponding to Los Angeles-Palm Springs-San Diego and surrounding environs.

Using the expandable data feeds portion 112 (which can be expanded by clicking with a pointing device on the “+” symbol adjacent a category of interest), the user can select which data feeds are of interest and make them available for display such that the data in the feeds of interest are superimposed as one or more layers on the map portion 102. Essentially any number of layers may be selected and superimposed, as desired. In addition, layers can originate from any of multiple different sources, e.g., they can be generated or customized locally (i.e., by the organization using the system) or they can be provided by third-party organizations such as Global Incident, as noted above.

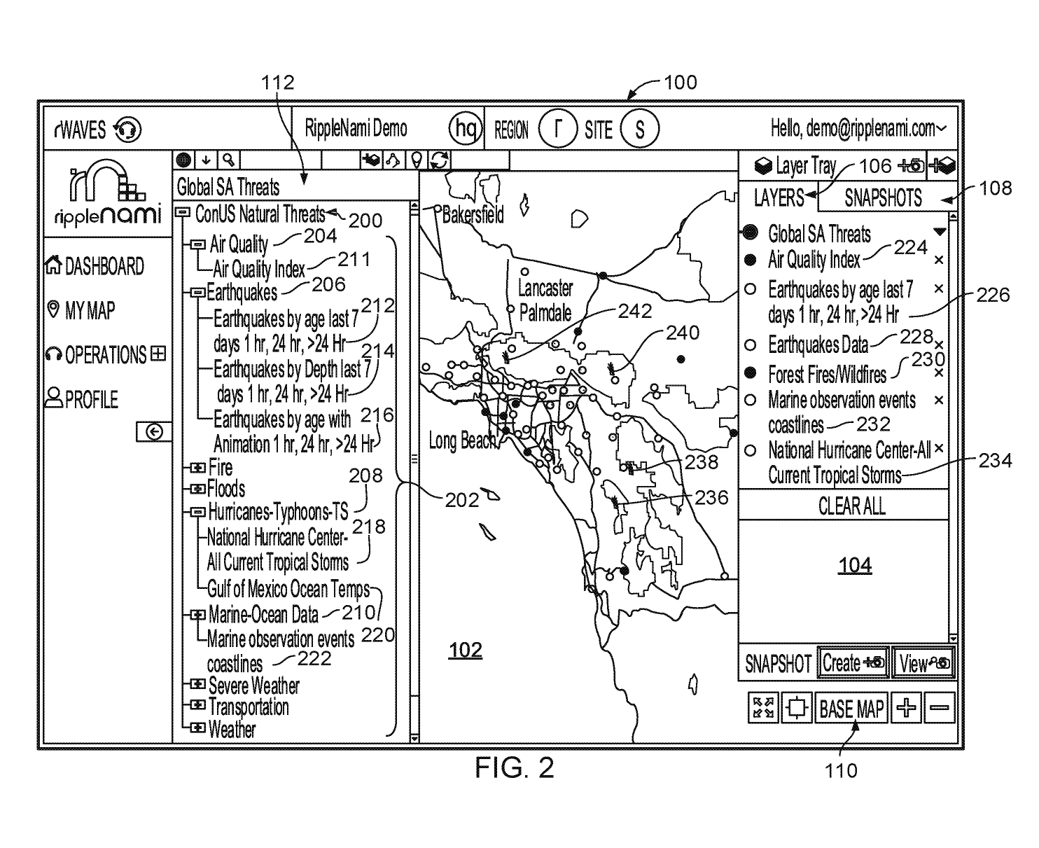

For example, as shown in the example screenshot of FIG. 2, the user has clicked on the “+” symbol adjacent the category “ConUS Natural Threats” 200 to expand that category into a list 202 of sub-categories, which in turn may themselves may be expandable to show data feeds available for selection. In this example, the user has expanded not only the top level category 200, but also sub-categories 204, 206, 208, and 210. Doing so caused seven different data feeds to become available to the user for selection, namely, data feeds 211, 212, 214, 216, 218, 220, and 222, which correspond to the respective topic areas shown in FIG. 2. Once expanded, the user can select (e.g., by selecting the data feed name) any or all of these data feeds to make them available in the tray 104.

In this example, as shown in tray 104, the user has clicked in portion 112 on data feeds 211, 212, 218, and 222 (among others not shown in list 202 including “Earthquakes Data” and “Forest Fires/Wildfires”). As a result, the tray 104 now has six available data feeds, specifically, Air Quality Index 224, Earthquakes by age last 7 days 226, Earthquakes Data 228, Forest Fires/Wildfires 230, Marine observation events 232, and National Hurricane Center 234. Although these six data feeds appear as available in tray 104, the characteristics corresponding to these data feeds are not automatically displayed on the map (though they could be in an alternative implementation). Rather, in the implementation shown in FIG. 2, the user first must click on the circle to the left of the data feed name in tray 104 to make the data feed active, thereby causing characteristics associated with that data feed to be superimposed on the map portion 102.

In this example, the user has clicked on the circles in tray 104 corresponding to the Air Quality Index data feed 224 and the Forest Fires/Wildfires data feed 230, thereby causing visual indicators (e.g., icons) representing events from those two data feeds to be displayed on the map 102. As shown in FIG. 2, making the Forest Fires/Wildfires data feed 230 active causes icons 236, 238, 240, and 242 to be displayed on the map 102. Each of those icons represents a different active fire event at the indicated geographical location. Note that the icons themselves impart information about their underlying nature in that they are depicted as flames, suggesting that they relate to fire events.

Similarly, visual indicators appearing as small circles (too numerous to enumerate) are caused to be displayed on map 102 by selection of the circle to the left of Air Quality Index 234, thereby making the corresponding data feed active. Each circle corresponds to a different air quality measurement at the indicated geographic location. Although not readily apparent from a black-and-white rendering of the screenshot shown in FIG. 2, in the functioning implementation the circles are displayed in different colors (red, yellow, green) that indicate the relative quality of the air at that location, e.g., a green circle indicates a high air quality index whereas a red circles indicates a low air quality index.

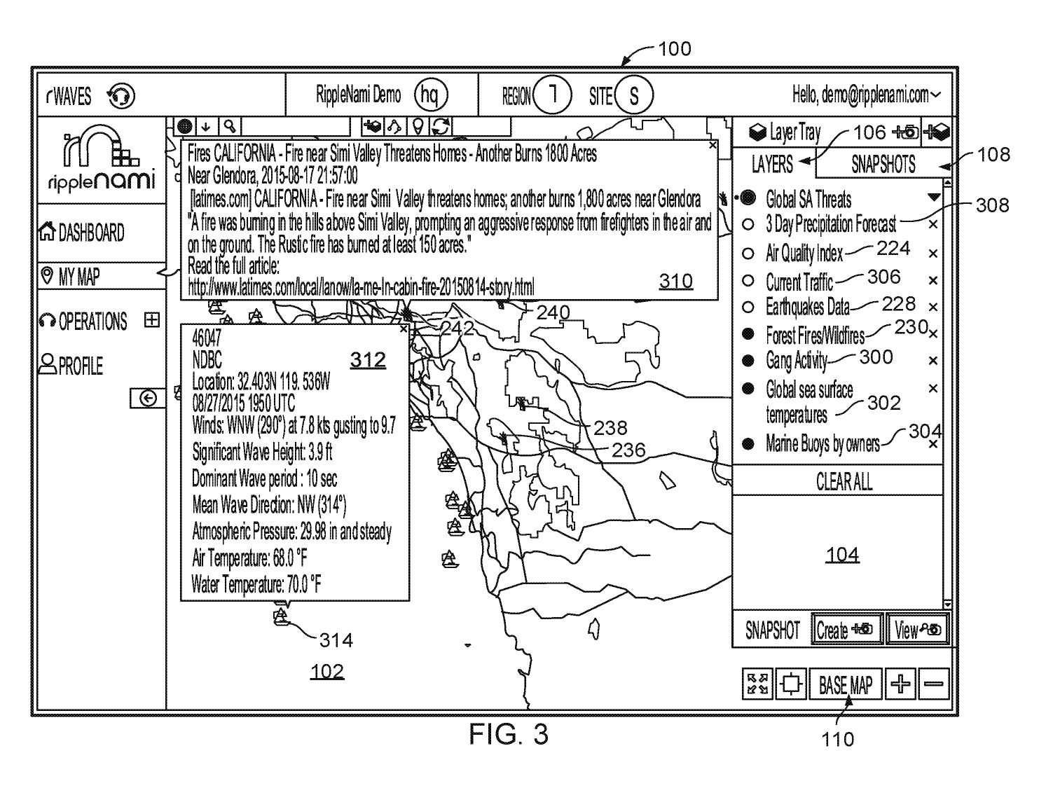

Note that although the visual indicators shown in the examples of FIGS. 2 and 3 are discrete entities (i.e., fire icons or small circles), essentially any other type of appropriate visual indicator or indication may be used as appropriate. For example, other visual indications may be implemented by varying opacity, color, color gradient, color intensity, three-dimensionality, hatching, texture, effect, or the like. As one example, if a certain region is known to be infected with an outbreak of a virus, that region could be visually indicated, e.g., by coloring the region a particular color (e.g., purple) in a translucent manner such that the underlying map information remains visible.

As shown in FIG. 3, the user can selectively turn on and off the display of data feed layers as desired by clicking on the circle to the left of the corresponding data feed name in tray 104. Similarly, the user can remove no longer relevant data feeds from tray 104 by clicking on the “x” to the right on the corresponding data feed name. And, of course, the user can add new data feeds to make them available in tray 104 in the manner described above.

In the example of FIG. 3, relative to the state shown in FIG. 2, the user has removed data feeds 226, 232, and 234 from tray 104, and has added data feeds 300, 302, 304, 306 and 308, thereby making them available to the user in tray 104 for activation. In this example, the user has deactivated the Air Quality Index data feed 224, has kept the Forest Fires/Wildfires data feed 230 active, and has activated the newly added data feeds Gang Activity 300, Global sea surface temperatures 302, and Marine Buoys by owners 304. As a result, the Air Quality Index visual indicator circles disappear from the map 102, and visual indications corresponding to data feeds 300, 302, and 304 are newly displayed on the map 102.

By themselves, display of the visual indications on the map 102 can impart at least two different items of information: (i) the location of the characteristic as represented by the visual indication, and (ii) potentially, the nature of the characteristic in question based on the appearance of the visual indication (e.g., the fire event icons appear as flames). To obtain additional information about a particular characteristic, the user may be able to simply click on that characteristic and, in one embodiment, an information box may open providing additional context and background about the characteristic in question. For example, as shown in FIG. 3, the user has clicked on both characteristics 242 and 314, thereby causing information boxes 310 and 312 to open, respectively. Because visual indicator 242 represents a fire event, the information in its information box 310 provides details and background on the fire represented by visual indicator 242. Similarly, because visual indicator 314 represents a marine buoy, its information box 312 provides details and background about the particular buoy in question.

Other features of the data visualization mapping platform described here include the ability to view the map 102 in different styles (e.g., as a regular base map, a satellite map, a topographical map, or a combination of any of those) using the drop down box indicated by user interface element 110. In addition, the Snapshots tab 108 can be used to capture a screenshot of the display screen at any desired point in time, and save it in an ordered manner for future reference.

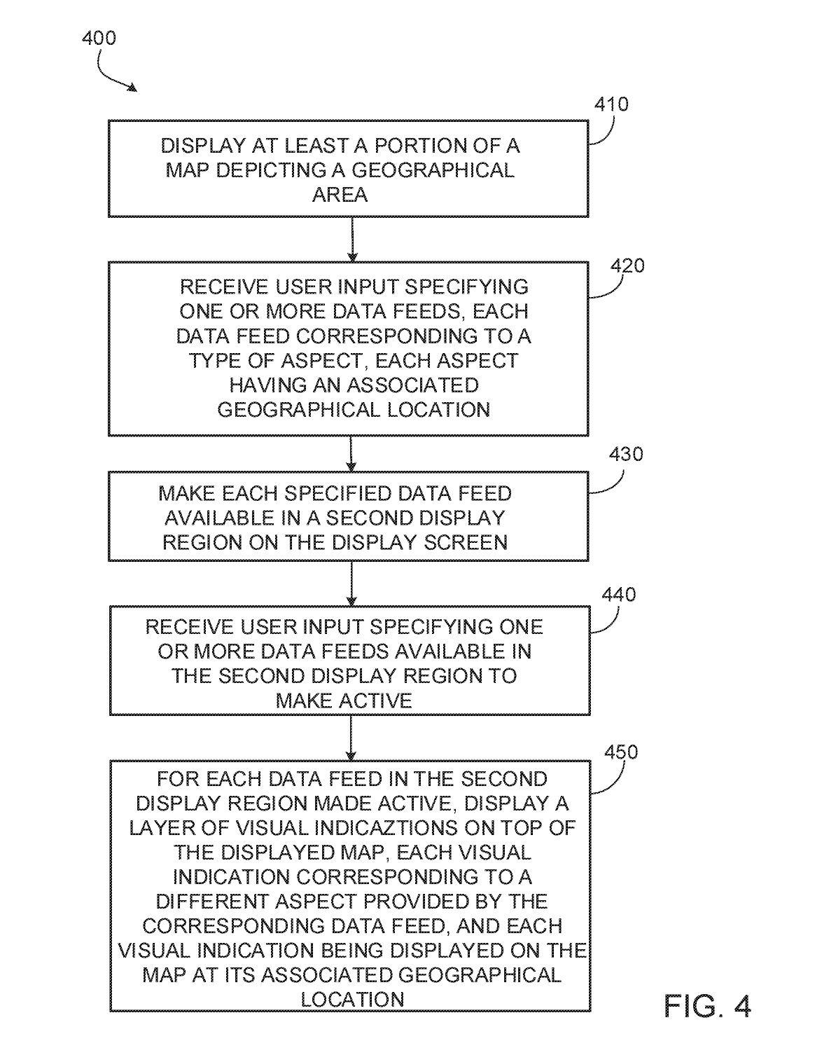

FIG. 4 is a flowchart of a process 400 of operation by a data visualization mapping system.

First, at 410, the system displays in a first region on a display screen, at least a portion of a map depicting a user-specified geographical area.

At 420, the system receives user input specifying one or more data feeds, each data feed corresponding to a type of characteristics, and each characteristic having an associated geographical location.

At 430, the system makes each specified data feed available in a second display region on the display screen (e.g., a layer tray).

At 440, the system receives user input specifying one or more data feeds available in the second display region to make active.

At 450, for each data feed in the second display region made active, the system displays a layer of visual indicators on top of the displayed map, wherein each visual indicator in the layer corresponds to a different characteristic provided by the corresponding data feed, and each visual indicator is displayed on the map at its associated geographical location.

In the examples described above, a user provides input to the system typically by selecting an item of interest, e.g., clicking on a particular data feed, visual indicator, or geographical area. However, the system may also accept input in the form of text entered via keyboard or voice-to-text input. In that case, the system may aid the user by providing an intelligent functionality in which the system supplies guesses (in the form of visual, selectable options) about what the user is seeking for or to do based on context, for example, the user's geographic location. For example, if the user is uploading a captured image to the system, the user can start typing a name for the image in the appropriate text field and, as the user is entering text, the system will guess at, and display, available options corresponding to the text entered up to that point in time based on the user's geographic location. If, for example, the user is located in Kenya, and initiates an image upload and naming sequence by typing the letter “K,” the system would display a list of potential names for the image beginning with “K” such that “Kenya” (the user's location) would be at the top of the list, and thus the easiest for the user to select.

Because some of the data feeds or other information maintained by the system may be confidential or otherwise private for one reason or another, or may have a different (e.g., lower) level of confidence, the system provides the ability for a system administrator to assign a user various levels of permission (in one example, five different levels, while in other examples the levels might be combinable granular levels and/or there may be more or fewer than five levels), in this example:

(1) User Managers can set users' permissions and access levels, have full data privileges to edit/view both private and public data, can access operations data.

(2) Data Managers are primary work force employees or special partnership programs. They have full data privileges to edit/view both private and public data.

(3) Private Data Users are users in first response organizations, Emergency operations Center collaborations and secure partnership collaborations. They can view all data (Private and Public) but cannot edit data tables.

(4) Public Data Users are users in collaborative partnerships and community programs. They can view only data marked as Public.

(5) No Access Users cannot view data marked as No Access. This permission level is used to monitor by location access.

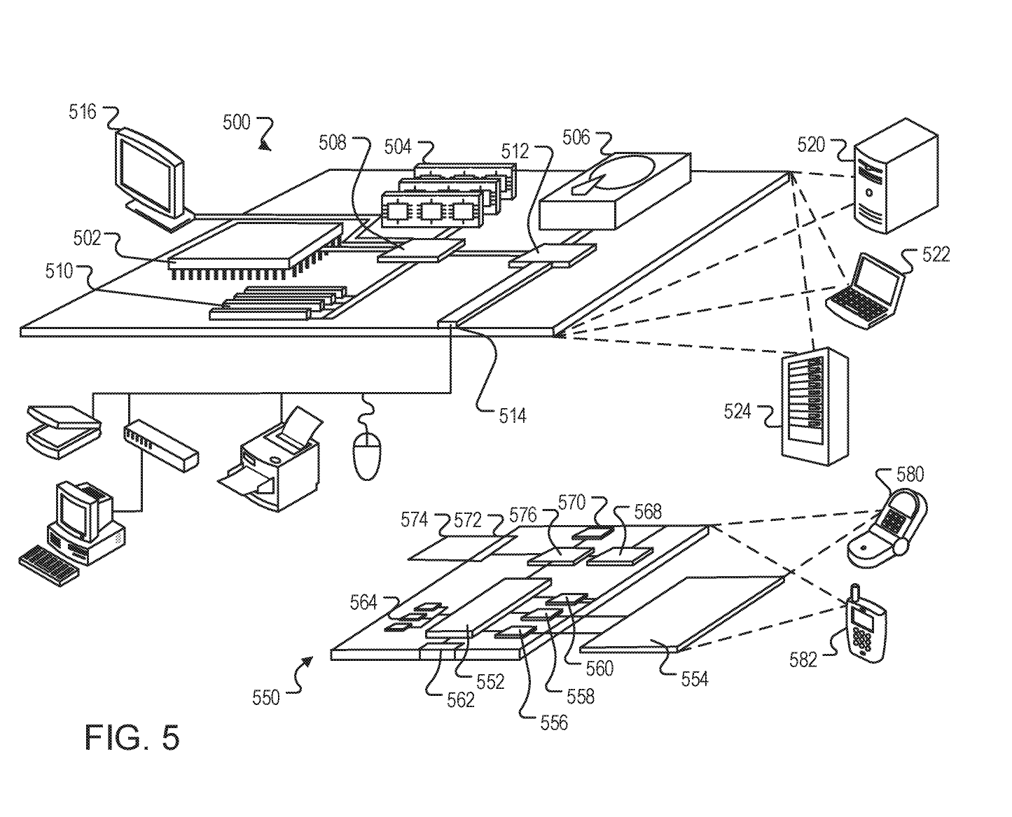

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. Additionally computing device 500 or 550 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. Additionally, the processor may be implemented using any of a number of architectures. For example, the processor 510 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provided in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552 that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, GPRS, LTE, LTE-Unlicensed Band, LTE-Direct, mesh network, or peer-to-peer network, among others. Such communication may occur, for example, through radio-frequency transceiver 568. In addition, short-range communication may occur, such as using a Bluetooth, Wi-Fi, or other such transceiver (not shown). In addition, a Global Navigation Satellite System (e.g., Global Positioning System or GPS) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550. Device 550 may also communicate visually using a video codec, which may receive captured or streaming visual information from a user or other source. Such captured or streaming visual information may include video from any of several different sources including drones, satellites, mobile phones and other mobile devices, crowd-sourcing activities, social network uploads, security cameras, and the like.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. Other steps may be provided, or steps may be eliminated, from the described flows, and other components may be added to, or removed from, the described systems.

A number of implementations have been described. Nevertheless, it will be understood that various modifications can be made without departing from the spirit and scope of the invention.

What is claimed is:

1. A computer-implemented method comprising:
displaying in a first region on a display screen, at least a portion of a map depicting a geographical area;
receiving user input specifying one or more data feeds, each data feed corresponding to a type of aspects, each aspect having an associated geographical location;
making each specified data feed available in a second display region on the display screen;
receiving user input specifying one or more data feeds available in the second display region to make active; and
for each data feed in the second display region made active, displaying a layer of visual indications on top of the displayed map, wherein each visual indication in the layer corresponds to a different aspect provided by the corresponding data feed, and each visual indication is displayed on the map at its associated geographical location.

2. The method of claim 1 wherein the displayed map is zoom-able and translatable to allow different or additional portions of the map to be displayed.

3. The method of claim 1 wherein the data feeds correspond to aspects including natural occurring events or human initiated events.

4. The method of claim 1 wherein one or more data feeds corresponds to aspects relating to available resources.

5. The method of claim 1 wherein one or more data feeds corresponds to aspects relating to a particular geographic region.

6. The method of claim 1 wherein the second display region comprises a tray that is superimposed over the first displayed region.

7. The method of claim 6 wherein receiving user input to make a data feed in the tray active comprises selecting an identifier corresponding to the desired data feed.

8. The method of claim 1 further comprising displaying a plurality of layers of visual indications on the displayed map, each layer of visual indications corresponding to a different type of aspects.

9. The method of claim 1 wherein the displayed visual indications have an appearance that suggests the aspect type to which they respectively correspond.

10. The method of claim 1 further comprising a third display region comprising a plurality of data feeds for selection by the user to make available in the second display region.

11. The method of claim 1 further comprises capturing a snapshot of the map with one or more layers of visual indications displayed thereon, the snapshot corresponding to a particular moment in time.

12. The method of claim 1 wherein the map is displayed as a base map, a terrain map, a satellite map, or any combination thereof.

13. A system comprising:
a memory storing machine instructions;
a processor to execute machine instructions stored in the memory, wherein execution of the machine instructions causes the system to perform operations including the following:
displaying in a first region on a display screen, at least a portion of a map depicting a geographical area;
receiving user input specifying one or more data feeds, each data feed corresponding to a type of aspects, each aspect having an associated geographical location;
making each specified data feed available in a second display region on the display screen;
receiving user input specifying one or more data feeds available in the second display region to make active; and
for each data feed in the second display region made active, displaying a layer of visual indications on the displayed map, wherein each visual indication in the layer corresponds to a different aspect provided by the corresponding data feed, and each visual indication is displayed on the map at its associated geographical location.

14. A non-transitory machine-readable medium comprising machine instructions that, when executed by a processor, cause one or more machines to perform operations comprising:
displaying in a first region on a display screen, at least a portion of a map depicting a user-specified geographical area;
receiving user input specifying one or more data feeds, each data feed corresponding to a type of aspects, each aspect having an associated geographical location;
making each specified data feed available in a second display region on the display screen;
receiving user input specifying one or more data feeds available in the second display region to make active; and
for each data feed in the second display region made active, displaying a layer of visual indications on the displayed map, wherein each visual indication in the layer corresponds to a different aspect provided by the corresponding data feed, and each visual indication is displayed on the map at its associated geographical location.
